(19) United States
(12) Patent Application Publication
(10) Pub. No.: US 2016/0165944 A1
(43) Pub. Date: Jun. 16, 2016

(54) METHOD FOR REDUCING THE SACCHARIDE CONTENT OF JUICE CONCENTRATES

(71) Applicant: CLARIANT INTERNATIONAL LTD., Muttenz 1 (CH)

(72) Inventors: Michael ZAVREL, Olching (DE); Danielle DENNEWALD, Muenchen (DE)

(21) Appl. No.: 14/906,154

(22) PCT Filed: Jul. 30, 2014
(86) PCT No.: PCT/EP2014/002093

§ 371 Date: Jan. 19, 2016

(30) Foreign Application Priority Data
Jul. 30, 2013 (EP) 13003793.0

(51) Int. Cl. A23L 2/80; A23L 2/38; A23L 2/84

(52) U.S. Cl. CPC A23L 2/80; A23L 2/84; A23L 2/382; A23V 2002/00

(57) ABSTRACT

The invention relates to a method for reducing the saccharide content in concentrated juices.

The present invention relates to a method for reducing the saccharide content in juice concentrates having an initial saccharide concentration or more than 20% (w/v).

On a large scale, juices are mostly produced from concentrates. This is essentially because raw juices can be reduced to a fraction (for example a fifth) of their initial volume in the country of origin or at the juice-producing factory, which has a positive effect on transport costs and the costs of further processing. For these reasons, the majority of the orange juice products, for example, that are sold worldwide are produced from concentrate.

During further processing, the juice concentrate is dilated to the original water content of the raw juice again by the addition of water. For a considerable time, however, consumers have been demanding more than simple juice products that are obtained by conventional dilution. Consumers are becoming increasingly more health conscious and in particular are increasingly more interested in low-calorie and reduced-calorie products.

It is therefore currently of particular interest to be able to offer juices whose saccharide content has been reduced significantly as compared with raw juices. Methods for reducing the saccharide content of juices are known in the prior art, A typical method for reducing the saccharide content of juices is described, for example, in U.S. Pat. No. 4,971,813, in which the sugar contained in the raw juice is converted into alcohol during a fermentation, and the alcohol so formed is removed by distillation.

The saccharide content of juices is far lower than that of juice concentrates, so that these methods are not suitable for concentrates as starting material. In particular in the case of juice concentrates having a saccharide content of more than 20% (w/v), it is frequently possible to break down only a portion of the saccharides, since the metabolization of the microorganisms used for the fermentation is slowed down considerably and often even inhibited by a rapidly increasing alcohol concentration. In addition, separation by distillation of the alcohol that has formed is particularly disadvantageous in this case in particular, since the saccharides that remain enter into so-called Maillard reactions with amine compounds present in the concentrate even with only gentle heating. Maillard reactions can lead to numerous undesirable compounds. In addition, an unattractive dark coloration of the concentrate is caused. These compounds also adversely affect the sensory properties of the concentrate and of the juice produced therefrom.

Because the majority of the juices and juice drinks that are available commercially worldwide are produced from concentrate, these methods are accordingly not of interest for the large-scale production of low-calorie juices and juice drinks.

The inventors of the present application have therefore set themselves the object of developing a method which does not have the disadvantages known in the prior art and in particular allows saccharides to be removed largely to completely from juice concentrates. In addition, the inventors of the present invention have set themselves the object of developing a method which, as well as largely to completely reducing the saccharides in juice concentrates, also yields an end product whose sensory and toxicological properties are not impaired as compared with the starting product.

Finally, the inventors of the present invention have set themselves the object of developing a method for reducing saccharides in juice concentrates which is suitable from the production point of view for applications in the large-scale sector and/or can be carried out in a cost-efficient manner.

It has now been found, surprisingly, that each of those objects is achieved by a method for reducing the saccharide content in juice concentrates having an initial saccharide concentration of more than 20% (w/v), comprising the steps:
a) contacting the juice concentrate with at least one microorganism,
b) fermenting the juice concentrate,
c) contacting the juice concentrate with a gaseous composition,
d) contacting the gaseous composition with an adsorber, wherein the adsorber comprises a zeolite,

wherein steps c) and d) are carried out simultaneously at least for a time.

Within the scope of step a), the term “contacting” is understood as meaning any type of contacting which appears to the person skilled in the art to be suitable for the purpose according to the invention. In a preferred embodiment, the contacting according to step a) of the method according to the invention is carried out by introducing the at least one microorganism into the juice concentrate.

Within the scope of the present invention, the term “microorganism” is preferably understood as meaning any microorganism which is capable of converting the saccharides contained in the juice concentrate into alcohol(s) and/or further volatile organic compounds. Within the scope of the present invention, the term “alcohol” is understood as meaning all compounds which the person skilled in the art subsumes under the term “alcohol”, in particular methanol, ethanol, propanol, butanol, pentanol and their respective isomers, wherein ethanol is particularly preferred. Within the scope of the present invention, the expression “further volatile organic compounds” is understood as meaning all compounds which the person skilled in the art subsumes under the expression “volatile organic compounds” within this context, such as, for example, organic acids (for example acetic acid) and/or organic esters. The “microorganism” is preferably a yeast or a bacterium. Particular preference is given to the yeasts of the genus Saccharomyces cerevisiae, or to yeasts and/or bacteria having similar fermentation properties, such as, for example, Pichia stipitis, Pichia segobiensis, Candida shehatae, Candida tropicalis, Candida boidinii, Candida tenuis, Pachysolen tannophilus, Hansenula polymorpha, Candida famata, Candida parapsilosis, Candida rugosa, Candida sonorensis, Issatchenkia terricola, Kloeckera apis, Pichia barkeri, Pichia cactophila, Pichia deserticola, Pichia norvegensis, Pichia membranaefaciens, Pichia mexicana, Torulaspora delbrueckii, Candida bovina, Candida picachoensis, Candida emberorum, Candida pintolopesii, Candida thermophila, Kluyveromyces marxianus, Kluyvezomyces fragilis, Kazachstania telluris, Issatchenkia orientalis, Lachancea thermotolerans, Clostridium thermocellum, Clostridium thermohydrosulphuricum, Clostridium thermosaccharo-lyticium, Thermoanaerobium brockii, Thermobacteroides acetoethylicus, Thermoanaerobacter ethanolicus, Clostridium thermoaceticum, Clostridium thermo-autotrophicum, Acetogenium kivui, Desulfotomaculum nigrificans and Desulfovibrio thermophilus, Thermoanaerobacter tengcongensis, Bacillus stearo-thermophilus and Thermoanaerobacter mathranii. Likewise very suitable within the scope of the method according to the invention are lactic acid bacteria and/or acetic acid bacteria which are able to convert saccharides into alcohol and/or further volatile organic compounds. It is also possible within the scope of the method according to the invention to use combinations of one or more or the mentioned microorganisms, wherein combinations of yeasts and acetic acid bacteria or combinations of yeasts and lactic acid bacteria are particularly preferred. The yeasts are particularly preferably at least one yeast from the genus Saccharomyces.

Within the scope of the present invention, the term “fermentation” is understood as meaning any type of biological conversion of organic substances by the at least one microorganism, which performs the fermentation within the scope of its metabolization. The temperature during the fermentation is chosen preferably between 10 and 50° C., more preferably between 20 and 40° C., particularly preferably between 25 and 35° C. In addition, the fermentation within the scope of the present invention is preferably an anaerobic or microanaerobic fermentation. The fermentation is preferably carried out in a stirred tank reactor or in a loop reactor or in an air-lift reactor or a bubble column reactor.

The term “contacting” within the scope of step c) is understood as meaning any type of contacting which appears to the person skilled in the art to be suitable for the purpose according to the invention. The contacting according to step c) is preferably carried out by passing the gaseous composition through the juice concentrate; the method of gas stripping known to the person skilled in the art is thereby particularly suitable. Gas stripping is carried out preferably at a pressure between 0.1 and 2 bar, particularly preferably between 0.5 and 1.5 bar. Particular preference is given to stripping at reduced pressure.

In order to achieve efficient gas stripping, the gas bubbles are preferably dispersed. This can be carried out by means of a stirrer which is so arranged that fine bubbles of the carrier gas are formed. Fine distribution of the gas bubbles is likewise possible by means of a sparger, a gassing element equipped with small holes.

It is additionally preferred to carry out the contacting according to step c) of the method according to the invention in a column in which a large material exchange surface is achieved by means of suitable built-in components or packing materials. The liquid and the gas stream thereby move particularly preferably counter-currently to one another, that is to say in opposite directions.

Within the scope of the present invention, the expression “juice concentrate” is understood as meaning any liquid of plant origin which is known to the person skilled in the art as being suitable for the method according to the invention, which liquid has been produced, for example, by pressing the crude plant material and the saccharide content of which is increased compared with the simple pressed juice. The plant source is preferably a fruit vegetable or fruit.

In a particularly preferred embodiment, the source of the juice concentrate is pressed juice from apple, pear, orange, mango, cherry, blueberry, blackcurrant, passion fruit, lychee, guava, strawberry, raspberry, blackberry, gooseberry, tomato, mirabelle, apricot, peach, grape, melon, plum, damson, carrot and/or blackthorn. Mixtures of all the above-mentioned plant raw materials are also suitable within the scope of the present invention.

The method according to the invention is particularly advantageous for juice concentrates having a saccharide content of more than 20% (w/v), wherein it is particularly suitable for a saccharide content of more than 25% (w/v), further preferably for a saccharide content of more than 30% (w/v), more preferably for a saccharide content of more than 35% (w/v). Likewise particularly preferred is a saccharide content of not more than 75% (w/v), more preferably not more than 55% (w/v) and most preferably not more than 45% (w/v), wherein it is possible within the scope of the present invention to combine all the preferred upper and lower limits with one another. Preferred concentration ranges for which the method according to the invention is particularly suitable are a saccharide content of from 25 to 75% (w/v) and from 30 to 55% (w/v)f as well as particularly preferably from 35 to 45% (w/v). Juice concentrates within those ranges have only poor storage stability because they have a high sugar concentration but also a high content of free water. Reducing the saccharide content using the methods known from the prior art, as described, for example, in U.S. Pat. No. 4,971,813, would here lead only to an insufficient reduction of the saccharides, so that further slight microbial decay can occur and the concentrates must be stored at very low temperatures—mostly deep frozen at 0° C—with a high outlay in terms of energy. In precisely such cases, a saccharide reduction by the method according to the invention can produce storage-stable juice concentrates which additionally have an excellent sensory and optical quality.

Within the scope of the present invention, the term, “saccharide” is understood, as meaning all carbohydrates which are known to the person skilled in the art as a constituent of juice concentrates as defined above. Within the scope of the present invention, the term “saccharide” is understood as meaning in particular monosaccharides (simple sugars, for example glucose, fructose), disaccharides (double sugars, for example sucrose, lactose, maltose) and oligosaccharides (multiple sugars, for example raffinose).

A composition is referred to as “gaseous” within the scope of the present invention when the particles thereof move freely at a large distance from one another and fill the available space uniformly. In comparison with the solid or liquid state of aggregation, the same mass in the gaseous state under normal conditions occupies approximately one to two thousand times the space.

Within the scope of the present invention, the expression “gaseous composition” can refer to air or one or more individual constituents of air, such as nitrogen, carbon dioxide and/or oxygen. Particular preference is given to gaseous compositions which do not comprise oxygen, wherein it is particularly preferred if the gaseous composition is fermentation gases, which are distinguished, as compared with air, by an increased carbon, dioxide content and no or only a very low oxygen content. In the case of an aerobic fermentation, it is possible that the fermentation gas has a content of carbon dioxide which is increased by at least 1 vol. % as compared with air, and in the case of an anaerobic fermentation it is possible that the content by volume of carbon dioxide is at least 10 vol. %

Fermentation gas(es) or gases without an oxygen component are particularly advantageous as the “gaseous composition” because the original color properties of the juice concentrate can then be better retained. It is additionally particularly preferred that the gaseous composition is the fermentation gas which forms during the fermentation of the juice concentrate mentioned in step b). In this case, the choice of fermentation gas as the gaseous composition is particularly advantageous since no additional costs and process steps are incurred for preparing the gaseous composition.

In a preferred embodiment, the present invention relates to a method in which, after step d) has been carried out, the gaseous composition is repeatedly contacted in the form of step c) with the juice concentrate. Within the scope of this preferred embodiment, it is thus possible to reuse the gaseous composition because, after the gaseous composition has passed, through the adsorber, the alcohol taken up in the fermenting juice concentrate remains in the adsorber and the gaseous composition can accordingly be used repeatedly for discharging further alcohol molecules from the fermenting liquid. Within the scope of this preferred embodiment it is additionally particularly preferred if the gaseous composition is fermentation gas.

The term “contacting” within the scope of step d) of the method according to the invention is understood as meaning any type of contacting which appears to the person skilled in the art to be suitable for the purpose according to the invention. Contacting within the scope of step d) preferably takes place by passing the gaseous composition through one (or more) column(s) containing the adsorber. A plurality of columns, particularly preferably from 2 to 6 columns, is preferably used. These columns can be connected in series or in parallel.

Within the scope of the present invention, the term “adsorber” is understood as meaning any material which comprises a zeolite and appears to the person skilled in the art to be suitable for the purpose according to the invention. The columns can thereby contain the same adsorber material or different adsorber materials.

Within the scope of the present invention, the term “zeolite” is understood as meaning any crystalline alumosilicate. Furthermore, within the scope of the present invention the term “zeolite” subsumes all materials which have the skeletal structure of a zeolite, such as, for example, silicalites.

Within the scope of a preferred embodiment, the amount of zeolite in the adsorber is at least 10% by weight, based on the total weight of the adsorber, preferably at least 25% by weight, further preferably at least 50% by weight, particularly preferably at least 75% by weight, in particular at least 85% by weight and most preferably at least 90% by weight. It is likewise particularly preferred that the adsorber comprises an amount of a zeolite having a pore diameter of not more than 8 Å (or not more than 7.5 Å, not more than 7 Å, not more than 6.5 Å, or in the pore diameter ranges mentioned below being particularly preferred) of at least 90% by weight, preferably at least 95% by weight, particularly preferably 100% by weight, based on the total weight of the adsorber. It is further preferred if the amount of zeolite having a pore diameter of not more than 8 Å (or not more than 7.5 Å, not more than 7 Å, not more than 6.5 Å, or in the pore diameter ranges mentioned below being particularly preferred) is chosen in the range of from 25 to 100% by weight, based on the total weight of the adsorber, preferably in the range of from 50 to 100% by weight, further preferably in the range of from 75 to 100% by weight and most preferably in the range of from 90 to 100% by weight, based on the total weight of the adsorber.

In a further preferred embodiment, the pore diameter of the zeolite is chosen in the range of from 5 to 8 Å, more preferably from 5.5 to 7 Å, further preferably from 6 to 6.5 Å. Particular preference is given also to a range of from 5 to 6.5 Å, more preferably from 2.4 to 3.4 Å and likewise particularly preferably from 1.5 to 3.5 Å.

In a further preferred embodiment, the ratio by mass of the adsorbed compounds to the mass of the zeolite having a pore diameter of not more than 8 Å is preferably in the range of from 1 to 1000, farther preferably from 2 to 500, particularly preferably from 3 to 200, likewise particularly preferably from 4 to 100 and most preferably in the range of from 5 to 50. This is the case in particular when alcohols are contained in the adsorbed compounds.

In a particularly preferred embodiment, the zeolite is a zeolite which, at a temperature of 40° C and a pressure of 1.013 bar absolute, binds at least twice the mass, preferably 2.5 times the mass and particularly preferably three times the mass of alcohols, preferably methanol, ethanol or propanol, as compared with water, when the liquid is an aqueous solution of at least 50 g/l alcohols. A gaseous mixture consisting of alcohols and water is preferably formed from, the liquid by stripping. It is thereby particularly preferred that at least 50% of the alcohols present in the liquid can be bound to the zeolite. These properties of the zeolite can be determined by stripping 500 ml of an aqueous solution comprising at least 50 g/l of the alcohol for 24 hours at a pressure of 1.013 bar and a temperature of 30° C with 1 liter of inert gas volume per minute and passing the gas stream enriched with the alcohol through a column filled with 400 g of the zeolite. The gas stream depleted of the alcohol is recycled. The total mass taken up is determined by determining the weight of the zeolite before and after the test. The amount of water can be determined by Karl-Fischer titration. The remainder of the bound mass is attributable to the adsorbed alcohol, A liquid consisting of 50 g/l of ethanol in water is preferably used .

Particular preference is given within the scope of the present invention to zeolites having an SiO₂/Al₂O₃ ratio (molar ratios of at least 50, preferably at least 150, likewise preferably at least 200, further preferably at least 300, particularly preferably at least 600, more particularly preferably at least 900 and most preferably at least 1200. It is further preferred if the SiO₂/Al₂O₃ ratio of the zeolite is chosen in the range of from 50 to 1200, preferably from 100 to 1200, further preferably from 300 to 1200 and most preferably from 600 to 1200.

Particular preference is given to zeolites of the beta or MFI type or to a silicalite.

Within the scope of the present invention, further possible constituents of the adsorber can be chosen from the group consisting of silica, bentonites, silicalites, silicates, clays, hydrotalcites, aluminum silicates, oxide powders, mica, glasses, aluminates, clinoptolites, gismondines, quartzes, active carbons, animal charcoal, montmorillonites, as well as organic polymers which are known to the person skilled in the art as being suitable for the method according to the invention, and mixtures thereof. Polytetrafluoro-ethylene (PTFE, Teflon) is additionally suitable as a constituent of the adsorber. Within the scope of the method according to the invention, the amount of a binder and/or PTFE in the adsorber is preferably not more than 75% by weight, more preferably not more than 50% by weight, further preferably not more than 25% by weight, particularly preferably not more than 20% by weight and most preferably not more than 10% by weight. It is particularly preferred if the amount of a binder and/or PTFE in the adsorber is chosen in the range of from 10 to 50% by weight, more preferably in the range of from 10 to 25% by weight.

The expression “pore diameter” is understood as meaning the maximum diameter of a theoretical sphere which can be embedded in the micropores of the zeolite.

The expression “molecule diameter” is understood as meaning the diameter of the maximum projection diameter of a molecule.

The method according to the invention further offers the advantage that molecules bound to the adsorber can be separated off and recovered in a simple and economically expedient manner. The molecule/molecules bound to the absorber is/are preferably recovered by desorption. Alternatively, the adsorber can be regenerated by combustion or oxidation or thermal decomposition or any other such chemical reaction of the adsorbed molecules.

It is possible in particular to carry out a selective desorption of the molecule/molecules bound to the adsorber, such as, for example, a short-chained alcohol, from the adsorber by increasing the temperature and/or reducing the pressure within the column. In a preferred embodiment of the method, the thermal energy is introduced directly onto the adsorbent packing via the column wall and optionally additionally via the heating coils inside the column. Temperatures between 25 and 300° C. and absolute pressures between 0 and 10 bar are preferred. Temperatures between 40 and 180° C and absolute pressures at reduced pressure, preferably between 0.01 and 1 bar, are particularly preferred.

A carrier gas is preferably used for discharging the desorbed molecule/molecules from the column. It is possible to use the same inert carrier gas that is also used within the scope of step c) of the method according to the invention. Likewise preferably, the temperature and the absolute pressure of the carrier gas are adjusted according to the above-described temperatures and absolute pressures inside the column. Heat exchangers and/or throttles or compressors arranged upstream are suitable for this purpose.

The Resorption can be carried out in fluidized bed operation.

The desorption can further take place
by displacement by means of other components;
thermally, that is to say by increasing the temperature of the adsorption agent (temperature-swing adsorption process (TSA));
by means of the so-called pressure-swing adsorption process (PSA), that is to say by lowering the pressure;
by chemical reaction;
by a combination of the above-mentioned methods.

Likewise preferably, a flushing gas can be used in the desorption. Preferred flashing gases are inert gases, the flushing gases are particularly preferably air, carbon dioxide, nitrogen, noble gases or mixtures thereof. It is further possible that the flushing gas comprises water. Particularly preferably, the temperature of the flushing gas is above the temperature of the compound material. Further preferably, the direction of flow in the desorption is contrary to the direction of flow of the liquid in the adsorption, that is to say so that the adsorption takes place against the gradient, formed in the adsorption, of the concentration of the organic component adsorbed on the compound material.

Within the scope of the method according to the invention, it is necessary that steps c) and d) are carried out simultaneously at least for a time. “At least for a time” means in this context that, over a period of at least 10% of the total duration of the method according to the invention according to steps c) and d), all the operations of steps c) and d) are carried out at the same time, preferably over a period of at least 20%, further preferably over a period of at least 30%, particularly preferably over a period of at least 40% and most preferably over a period of at least 60%. Furthermore, it is particularly preferred within the scope of the method according to the invention that steps b), c) and d) are carried out simultaneously at least for a time. “At least for a time” likewise means in this context that, over a period of at least 10% of the total duration of the method according to the invention according to steps b) to d) , all the operations of steps b) to d) are carried out at the same time, preferably over a period of at least 20%, further preferably over a period of at least 30%, particularly preferably over a period of at least 40% and most preferably over a period of at least 60%.

By carrying out steps c) and d) of the method according to the invention at the same time at least for a time, it is ensured that the alcohol produced by the fermentation is regularly discharged from the fermenting juice concentrate via the gaseous composition. It is particularly preferred if the alcohol content in the fermenting juice concentrate is maintained at not more than 14 vol. %, preferably not more than 12 vol. %, further preferably at not more than 10 vol. %, in particular at not more than 8 vol. % and most preferably at not more than 5 vol. %.

In the course of an economical procedure it is additionally preferred within the scope of the present invention if, within the scope of the method according to the invention, steps c) and d) are repeated at least once, preferably from 2 to 50,000 times, more preferably from 50 to 40, 000 times, further preferably at least from 500 to 3500 times. It is particularly preferred to carry out the method according to the invention as a continuous procedure. The expression “continuous procedure” is within the scope of the standard knowledge known to the person skilled in the art. A preferred embodiment of the method according to the invention is directed to a method, in which, after step d) has been carried out, the gaseous composition is repeatedly contacted in the form of step c) with the juice concentrate.

In a particularly preferred embodiment, the present invention comprises a method for reducing the saccharide content in juice concentrates having an initial saccharide concentration of more than 20% (w/v) and up to 75% (w/v), comprising the steps:
a) contacting the juice concentrate with at least one microorganism selected from the group consisting of yeasts and bacteria and mixtures thereof,
b) fermenting the juice concentrate at a temperature chosen in the range of from 25 to 35° C. under anaerobic or microanaerobic conditions,
c) contacting the juice concentrate with a gaseous composition,
d) contacting the gaseous composition with an adsorber, wherein the adsorber comprises a zeolite selected from the group consisting of MFI zeolites, silicalites and beta zeolites and mixtures thereof,
   wherein steps b), c) and d) are carried out at the same time over a period of at least 10%, preferably over a period of at least 40%, of the total duration of the method according to the invention according to steps b) to d). In a particularly preferred embodiment, the gaseous composition is fermentation gas which has formed during the fermentation according to step b) of the method according to the invention.

In a particularly preferred embodiment, the present invention comprises a method for reducing the saccharide content in juice concentrates having an initial saccharide concentration of more than 30% (w/v) and up to 55% (w/v), comprising the steps:
a) contacting the juice concentrate with at least one microorganism selected from the group consisting of yeasts and bacteria and mixtures thereof,
b) fermenting the juice concentrate at a temperature chosen in the range of from 25 to 35° C. under anaerobic or microanaerobic conditions,
c) contacting the juice concentrate with a gaseous composition,
d) contacting the gaseous composition with an adsorber, wherein the adsorber comprises a zeolite selected from the group consisting of MFI zeolites, silicalites and beta zeolites and mixtures thereof,

wherein steps b), c) and d) are carried out at the same time over a period of at least 10%, preferably over a period of at least 40%, of the total duration of the method according to the invention according to steps b) to d), and wherein the gaseous composition, after step d) has been carried out, is repeatedly contacted in the form of step c) with the juice concentrate. In a particularly preferred embodiment, the gaseous composition is fermentation gas which has formed during the fermentation according to step b) of the method according to the invention.

It is possible within the scope of the present invention that all of the described preferred embodiments are combined with one another.

The present invention additionally comprises the use of a method as described above, for producing a juice concentrate with a reduced saccharide content.

Water and optionally flavorings can be added to the reduced-saccharine juice concentrate in order to produce a reduced-saccharide juice.

### EXAMPLE

The present invention is explained in greater detail below by means of an example. It is emphasized that the example too serves merely to illustrate particular embodiments and does not limit the scope of the present application in any way.

### Example

### Reduction of the sugar content in orange juice concentrate

0.5 liter of orange juice concentrate was inoculated with Saccharomyces cerevisiae and fermented for 300 hours at 30° C. under anaerobic conditions. A portion of the CO₂ thereby produced was diverted from the waste air and introduced into the liquid volume again at 1 liter/minute. Upon leaving the liquid, the gas stream enriched with ethanol was passed, by means of a membrane pump (KNF Neuberger, Germany) and a volume flow controller (Swagelok, Germany), through a glass column (Gassner Glastechnik, Germany) which was filled with 2000 g of zeolite molded bodies (ZSM-5, H-form, SiO₂/Al₂O₃=1000; inert binder, manufacturer: Clariant AG). The gas stream depleted of ethanol was then fed back into the reactor after leaving the glass column. After 300 hours, the test was terminated and the residual ethanol and sugar concentrations in the receiver were quantified by chromatography. The results showed a substantial reduction in the sugar content, and the ethanol concentration achieved was below 5%,

What is claimed is:

1. A method for reducing the saccharide content in juice concentrates having an initial saccharide concentration of more than 20% (w/v), comprising the steps:
a) contacting the juice concentrate with at least one microorganism,
b) fermenting the juice concentrate,
c) contacting the juice concentrate with a gaseous composition,
d) contacting the gaseous composition with an adsorber, wherein the adsorber comprises a zeolite,
wherein steps c) and d) are carried out simultaneously at least for a time.

2. The method as claimed in claim 1, wherein steps b), c) and d) are carried out simultaneously at least for a time.

3. The method as claimed in claim 1, wherein the juice concentrate has a saccharide concentration of more than 20 and up to 75% (w/v).

4. The method as claimed in claim 1, wherein the juice concentrate has a saccharide concentration of from 30 to 55% (w/v).

5. The method as claimed in claim 1, wherein, after step d) has been carried out, the gaseous composition is repeatedly contacted in the form of step c) with the juice concentrate.

6. The method as claimed claim 1, wherein the at least one microorganism is selected from the group consisting of yeasts and bacteria and mixtures thereof.

7. The method as claimed in claim 1, wherein the zeolite is selected from the group consisting of MFI zeolites, silicalites and beta zeolites and mixtures thereof.

8. The method as claimed in claim 1, wherein the fermentation of the juice concentrate according to step b) is carried out under anaerobic or microanaerobic conditions.

9. The method as claimed in claim 1, wherein the adsorber additionally comprises at least one binder selected from the group consisting of silica, silicates, bentonite, PTFE and mixtures thereof.

10. A use of the method as described in claim 1, for producing a juice concentrate with a reduced saccharide content.
